(19) United States
(12) Patent Application Publication
(10) Pub. No.: US 2024/0140504 A1
(43) Pub. Date: May 2, 2024

(54) ORIENTATION-BASED POSITION DETERMINATION FOR RAIL VEHICLES

(71) Applicant: Siemens Mobility GmbH, München (DE)

(72) Inventors: Christoph Seidel, München (DE); Kristian Weiss, Berlin (DE)

(21) Appl. No.: 18/557,759

(22) PCT Filed: Jan. 26, 2022
(86) PCT No.: PCT/EP2022/051754

§ 371 Date: Oct. 27, 2023

(30) Foreign Application Priority Data
Apr. 30, 2021 (DE) 10 2021 204 372.0

(51) Int. Cl. B61L 25/02; B61L 15/00

(52) U.S. Cl. CPC B61L 25/025; B61L 15/0081; B61L 25/023; B61L 2205/04

(57) ABSTRACT

A method for orientation-based localization or position determination of a rail vehicle includes capturing sensor data that are correlated with a change of orientation of the rail vehicle. A time-dependent change of orientation of the rail vehicle is determined on the basis of the sensor data. Moreover, an estimated velocity of the rail vehicle is determined on the basis of the captured sensor data and/or on the basis of additionally captured sensor data. A distance-dependent orientation of the rail vehicle is subsequently determined on the basis of the estimated velocity and the time-dependent change of orientation of the rail vehicle. Furthermore, an absolute position of the rail vehicle is determined by comparing the determined distance-dependent orientation of the rail vehicle with reference data of a distance-dependent orientation. A localization facility and a rail vehicle are also described.

### DESCRIPTION

The invention relates to a method for orientation-based localization of a rail vehicle. In addition, the invention relates to a localization facility. The invention relates, moreover, to a rail vehicle.

Knowledge of the position of a rail vehicle can be used for solving many different tasks and problems. For example, the journey of the rail vehicle can be automatically controlled as a function of position. In general, the traveling behavior of a rail vehicle, in particular the velocity or stopping maneuver, can be controlled as a function of position.

One possibility for determining the position of a vehicle can be implemented with the aid of a satellite-based navigation system (GNSS =global navigation satellite system). However, satellite signals are not always available and, in addition, the accuracy of satellite navigation is limited to a few meters in systems with a standard structure. Improved levels of accuracy can be achieved, for example, by RTK position measurements. With RTK position measurements, two receiving antennas are required: the first is the reference station, the second, what is known as the rover, whose position is determined by three-dimensional polar attachment to the reference station according to the baseline method. Usually, a network of reference stations provided by an operator exists. Permanently installed reference stations have to be provided therefore, and this contributes to significantly increased resource costs in comparison with conventional satellite navigation.

A different approach to localization is characterized by Simultaneous Localization and Mapping (SLAM). In this case, sensors create a map of the environment of a rail vehicle and determine its physical location within this map. An absolute position of the rail vehicle can then be determined by comparing the created map with a reference map. A particular challenge with this approach consists in that an appropriately detailed map is required for accurate localization and for generating a detailed map, the exact position of the sensor unit has to be known. The creation of the map and the self-localization cannot be achieved independently of each other therefore. The map is determined incrementally, it being possible to determine the movement of the rail vehicle on the basis of changes in position of points on the map. Since it is never possible to exactly determine the movement of the rail vehicle between two measurements, however, the calculated position of the rail vehicle will deviate increasingly from the true position. To preserve the consistency of the map, it is necessary to identify with the aid of an algorithm when a known part of the environment is being measured again. These methods are often very CPU-intensive and are possibly rather inaccurate.

It is therefore the object to provide a method and an apparatus for determining the position of a rail vehicle, which operates with reduced expenditure and sufficient accuracy compared to conventional methods.

This object is achieved by a method for orientation-based localization of a rail vehicle as claimed in claim 1, a localization facility as claimed in claim 12, and a rail vehicle as claimed in claim 13.

In the inventive method for orientation-based localization of a rail vehicle, sensor data is captured, which is correlated with a change of orientation of the rail vehicle. The sensor data can be captured, for example, with an angle-resolving sensor, preferably an angle-resolving radar sensor. The sensor is preferably arranged on the front face of the rail vehicle and oriented in the direction of travel or in the direction of the longitudinal axis of the rail vehicle. The sensor can also be arranged at a different locations on the rail vehicle, however. As will be explained in more detail later, a rail vehicle can also have a plurality of sensors, also arranged at different locations on the rail vehicle. The sensors can also have different modes of operation or their measurements can be based on different physical principles. A time-dependent change of orientation of the rail vehicle is determined on the basis of the sensor data. In addition, an estimated velocity is determined on the basis of the captured sensor data and/or on the basis of additionally captured sensor data. In contrast to a velocity determined on the basis of the position of the rail vehicle to be determined by the inventive method or on the basis of a change in position over time derived therefrom, an estimated velocity of this kind is less accurate. If this velocity is determined on the basis of sensor data of sensors, which sample the environment of the rail vehicle, as a velocity relative to the environment, then a “local velocity” of the rail vehicle can be referred to, and this is determined by the described estimate. The estimated velocity can also be determined on the basis of additional sensor data, however, which is based on a global system, such as satellite navigation data, for example.

A distance-dependent orientation of the rail vehicle is determined on the basis of the estimated velocity and the time-dependent change of orientation of the rail vehicle. Orientation, also called “heading”, should be taken to mean the direction in which a longitudinal axis running through the rail vehicle is directed. This direction can be oriented in the direction of the section of track or tangentially to the section of track. Furthermore, an absolute position of the rail vehicle is determined by comparing the determined distance-dependent orientation of the rail vehicle with reference data of a distance-dependent orientation. The reference data can be obtained, for example on the basis of map data in which a course of a rail is indicated. It can also be obtained by starting to travel a route and a simultaneous orientation measurement, or a combination of both of said procedures.

Advantageously, no infrastructure-side systems, such as, for example, satellites, balises, magnetic loops, are required for the localization of the rail vehicle and gray codes or optical markers are not required, either. Advantageously, costs are reduced compared to the methods connected with upgrading the infrastructure. Despite the reduced expenditure, increased accuracy is achieved compared to simple, conventional localization methods. In contrast to approaches using the SLAM technique already mentioned, inventively no feature points or landmarks have to be found again in successive time steps. Furthermore, a robust localization may be achieved, which, in particular in contrast to wheel odometry, are also robust against slip and slide.

The inventive localization facility has an orientation sensor unit for capturing sensor data, for example from the environment of a rail vehicle, which is correlated with a change of orientation of the rail vehicle. A change of orientation determining unit for determining a time-dependent change of orientation of the rail vehicle on the basis of the captured sensor data also forms part of the inventive localization facility. Furthermore, the inventive localization facility comprises a velocity determining unit for determining an estimated velocity of the rail vehicle on the basis of the captured sensor data and/or additionally captured sensor data. In addition, the inventive localization facility has an orientation determining unit for determining a distance-dependent orientation of the rail vehicle on the basis of the estimated velocity and the captured sensor data. The inventive localization facility has, moreover, a localization unit for determining an absolute position of the rail vehicle by comparing the determined distance-dependent orientation of the rail vehicle with reference data of a distance-dependent orientation. The inventive localization facility shares the advantages of the inventive method for orientation-based localization of a rail vehicle.

The inventive rail vehicle has the inventive localization facility. Furthermore, the inventive rail vehicle comprises a control unit for controlling a journey of the rail vehicle on the basis of a position of the rail vehicle determined by the localization facility and a traction unit for driving the rail vehicle on the basis of control commands of the control unit. The inventive rail vehicle shares the advantages of the inventive localization facility.

Some components of the inventive localization facility can, possibly after supplementation with hardware systems, such as a sensor unit, for example, be embodied for the most part in the form of software components. This relates, in particular, to parts of the change of orientation determining unit, the velocity determining unit, the orientation determining unit and the localization unit.

Basically, some of these components, especially when particularly fast calculations are required, can also be implemented in the form of software-assisted hardware, for example FPGAs or the like, however. Similarly, the required interfaces, for example when only an acquisition of data from different software components is required, can also be embodied as software interfaces. They can also be embodied as interfaces constructed in terms of hardware, however, which are actuated by suitable software.

An implementation largely in terms of software has the advantage that even computer systems already present in a rail vehicle can also be easily retrofitted after a potential supplementation with additional hardware elements, such as additional sensor units, by way of a software update in order to work inventively. In this regard, the object is also achieved by a corresponding computer program product with a computer program, which can be loaded directly into a memory facility of such a computer system, with program segments in order to carry out the steps of the inventive method, which can be implemented by way of software, when the computer program is executed in the computer system.

Apart from the computer program, such a computer program product can optionally also comprise additional constituent parts, such as documentation and/or additional components, also hardware components, such as hardware keys (dongles, etc.) in order to use the software.

A computer-readable medium, for example a memory stick, a hard disk or another transportable or permanently installed 6 data carrier, on which the program segments of the computer program, which can be read in and executed by a computer unit, are stored, can serve for transportation to the storage facility of the computer system and/or for storage on the computer system. The computer unit can have, for example, one or more cooperating microprocessor(s) or the like for this purpose.

The dependent claims and the following description respectively contain particularly advantageous embodiments and developments of the invention. In particular, the claims of one category of claims can also be developed analogously to the dependent claims of a different category of claims and the descriptions thereof. In addition, the various features of different exemplary embodiments and claims can also be combined within the framework of the invention to form new exemplary embodiments.

In one embodiment of the inventive method for orientation-based localization of a rail vehicle, the comparison comprises determining a cross-correlation function between the determined distance-dependent orientation of the rail vehicle and the reference data of a distance-dependent orientation of a rail vehicle. In addition to the orientation of the rail vehicle, the velocity of the rail vehicle can also be determined on the basis of the sensor data and a covered distance can be determined on the basis of the determined velocity of the rail vehicle to standardize the measuring signal to the reference signal or the orientation data determined by measurement with sensors to the reference data.

A shared sampling interval is defined for the reference data, which is based on map data, and the sensor data, the measurement data therefore, which interval should not be too broadly selected in order to not lose resolution. The orientation for the two datasets is subsequently linearly interpolated in accordance with the selected sampling.

The two datasets can comprise, for example, complex phases i*hₘₑₐₛ, i*hₘₐₚ of orientation angles, which are correlated with one another with a complex cross-correlation function r(k):

r(k)=Σ_{n=-∞}^{n=∞}e^{-ih}^{ₘₐₚ}^{[n]}e^{ih}^{ₘₑₐₛ}^{[n+k]}. (1)

The two variables n and k are whole numbers, which count the sampling intervals. During the comparison, a maximum of the complex cross-correlation function r(k) is determined. At the location kₘₐₓ of the maximum it is determined whether the maximum is sufficiently distinctive. This means, in particular, that it is determined whether the maximum of the correlation function r(k) of the path already covered is sufficiently large or distinct.

If this is the case, then the location of the maximum km ax describes the offset between the measuring signal and the reference signal. The distinctness of the maximum can also be determined by evaluating an autocorrelation function of the distance-dependent orientation determined by measuring via the distance already covered. If the autocorrelation function has only secondary maxima below a predetermined threshold value, localization within the previously covered route is possible. A correlation in a search area can also be estimated by way of prior knowledge based, for example, on satellite navigation, positioning marks or mobile network data and it can be determined whether the correlation function estimated in this way has an adequately pronounced maximum for a distinct localization to be possible.

general, it can be stated that the level of cross-correlation is a measure of the quality for estimating the position of a rail vehicle.

The complex phase describes the difference in the phase of the comparison signal from the reference signal and can be used as a correction value for the orientation measurement. The correct starting point of the measuring signal in the reference signal can be determined on the basis of the determined offset. The current route point is subsequently determined via the projection of the covered distance on the mapped route. Furthermore, an absolute or global position can be determined from map data with the aid of coordinates allocated to the route points.

The graph of the distance-dependent orientation of the map and the measurement can also be divided into constant sections with the aim of reducing the volume of data and possibly eliminating “discontinuities”, that is to say, deviations from the heading of the course of the route, for example slight variations resulting due to an S-course. Map sections which have a good correlation result are subsequently preferred for localization.

The measuring signal used for the cross-correlation, or the distance-dependent orientation determined on the basis thereof can be compressed or stretched in constant regions to increase the correlation. In this way, an error in an odometric distance estimation can be compensated or determined and more accurate localization thus made possible.

The cross-correlation function r(k) can alternatively also comprise a real correlation function. However, as a rule, a complex cross-correlation function r(k) supplies more distinct maxima, so it is better suited to localization.

One of the following types of sensor system can be used to capture the sensor data, which is correlated with a change of orientation of the rail vehicle:
a radar system,
an inertial measuring unit,
a satellite navigation system,
an acceleration sensor system,
a magnetic field sensor system,
an ultrasound sensor system,
a laser-based measuring system,
a measuring system based on the modulation of radioactive radiation,
a camera-based, preferably stereo camera-based measuring system.

If a radar system is used, then, in particular, the REMER method (REMER=Robust Ego Motion Estimation with Radar) can be used to determine a change of orientation and a velocity of a rail vehicle. Said REMER method is described in a German patent application with the official file reference 10 2020 206 771.6.

A change of orientation of a rail vehicle can also be determined with an inertial measuring unit.

Different measuring methods with different sensors or transmitting/receiving systems can also be combined. For example, a rough position of a rail vehicle can be determined with the aid of a satellite navigation system, knowledge of which position can be used to correlate reference data of a corresponding rail section with the signal of an orientation of the rail vehicle based on a measurement.

For example, 3D data from the environment of a rail vehicle can also be captured and/or generated, with which an exact estimate of a positioning of the rail vehicle is possible.

Depth sensor data can also be captured as 3D data from the environment. Such a depth sensor allows three-dimensional sampling of a region to be monitored, whereby a position or an orientation of a rail vehicle can be determined more accurately in the three-dimensional space.

The 3D data can be captured from the monitored environment, for example by a LIDAR unit or a stereo camera. LIDAR units or stereo cameras are also used for detecting collision obstacles for a rail vehicle. Advantageously, these special sensor units can be used additionally for self-localization of the rail vehicle without additional sensor unit[s] having to be installed.

The 3D data can preferably be reproduced as a depth image or as a point cloud. Point clouds are suitable, in particular, for capturing the environment by way of LIDAR systems, or, in general, laser-based systems, since the volume of data to be processed is limited thereby.

The 3D data can also be determined on the basis of video data from a mono camera and on the basis of detection of the optical flow of the determined video data. The concept of determining 3D data on the basis of capture of the optical flow may be implemented, for example, by applying a “structure from motion” algorithm. Advantageously, a complex 3D camera can be dispensed with and three-dimensional items of information of the environment of the rail vehicle can still be generated, on the basis of which an orientation and position of the rail vehicle can be determined.

For orientation-based localization of a rail vehicle, first of all a starting point is determined in the reference data for the captured orientation data, preferably by comparing the determined distance-dependent orientation of the rail vehicle with reference data, which starting point corresponds to a starting point of a traveled route in the reference data. Furthermore, an absolute start position of the rail vehicle is determined by way of an absolute position in a map allocated to the starting point in the reference data. A dynamic absolute position can then be determined by determining a covered path on the basis of the correlated reference data and a projection of the length of the covered path on a course of the route indicated in the map. Advantageously, an exact global position of the rail vehicle can be determined whose accuracy is limited only by the accuracy of the measurements and the accuracy of the map used and by the geodetic model forming the basis of the map.

The reliability of the determined absolute position of the rail vehicle can be checked by one of the following methods:
determining confidence values on the basis of the determination of the orientation values,
determining on the basis of the curve shape of the cross-correlation function, whether a distinct comparison is possible between the determined distance-dependent orientation of the rail vehicle and the reference data,
comparing sequential correlation shifts, which are mapped onto the trajectory of the rail vehicle in the longitudinal direction, with a currently measured velocity of the rail vehicle in order to check whether the estimate is plausible in the course of time.

The confidence values are determined on the basis of the peak height of the cross-correlation function, standardized over the route length, between the orientation based on the measuring signal and the reference data-based orientation as well as on the basis of the size of the secondary maxima of the autocorrelation function of the measurement and the cross-correlation function between the measurement and the route-based reference data.

Examination of the curve shape comprises examining the size of secondary maxima, the spacing of these secondary maxima as well as the acuteness of the main maximum of the cross-correlation function. An acute maximum allows a more precise localization than a less pronounced maximum. In addition, the greatest local maximum is determined besides the absolute maximum of the cross-correlation function as well as its spacing from the absolute maximum.

The comparison of sequential correlation shifts comprises comparing a route distance of positions obtained by the inventive method from at least two measuring instants, which that do not necessarily follow each other, with a route, which is determined by the velocity estimation method used in the position estimation and by integration of the estimated velocity data in the corresponding measuring period. Advantageously, an incorrect localization can be identified. In this way, for example, determined route sections, which are not suitable for localization by way of the inventive method, can also be determined.

The extent of correlation, the ratio of the maximum of the correlation function to the length of the corresponding route section therefore can also be used when checking whether a correlation result is valid. In the case of no correlation result within a predefined tolerance, this can point to a change in the course of the track. This change can possibly be transmitted to a central agency for checking the course of the track if the correlation result undershoots a threshold value. For example, bypassing behavior, which is as yet unknown to the central agency, in a route section can thus be made known.

A sensor orientation of sensors of a rail vehicle can be calibrated by the inventive correlation of uncalibrated measurement data with reference data. The orientation of the sensors of a rail vehicle has a certain deviation from a desired value. In order to avoid inaccuracies when measuring sensor data and during its processing, a calibration can advantageously be carried out by comparing orientation values based on sensor data with reference data. The deviation corresponds to a linear trend or a gradient of the orientation values of the measurement data. A deviation angle β can then be calculated on the basis of this gradient Δφ/Δs.

For a straight-line course of the route where α=0, the following results for the deviation

$$β = arc sin ( l \frac{Δφ}{Δ s} ) , \qquad ( 2 )$$

where 1 describes the spacing of the sensor from the turning point. The rotation or deviation β can also be determined by way of regular checking.

Status monitoring and/or asset monitoring can also be carried out on the basis of the localization and/or calibration.

For example, a map can be created during status monitoring by way of a specified trajectory. Defects and/or errors in an existing map can also be identified and eliminated on the basis of the specified trajectory. In addition, defects in a physical rail of a track system can also be determined.

For example, a drop on one side, which manifests itself by way of a side motion of a rail vehicle at a place at which this would not be expected, can be determined. Status monitoring can also comprise identifying a yawing or a side motion of the rail vehicle since such a deviation manifests itself in the measured orientation of the rail vehicle.

The length of a rail vehicle or train can also be determined by way of supplementation of a rear sensor. Like a sensor arranged on the front of the rail vehicle, the rear sensor likewise supplies an orientation signal, which is correlated with the course of the route. The orientation signals of the front sensor and of the rear sensor can be correlated against each other. The displacement determined during correlation then yields the length of the rail vehicle or train. Alternatively, the orientation values can be correlated with reference data on the basis of the front sensor and the rear sensor. The difference in the global position of the front and the end of the train can then be determined as the train length. For example, in this way it is possible to observe how the length of a train changes when moving off, braking and cornering.

Other spacings or lengths of a train or rail vehicle can also be measured when a sensor is not arranged on the back or at the end of the relevant rail vehicle, but instead somewhere between the start and the end of the relevant rail vehicle.

Knowledge of an accurate global position of a rail vehicle can also be used for identifying stationary targets as landmarks for mapping or for relocalization.

Furthermore, the orientation of individual rail cars of a train can be determined more accurately on the basis of the course of the orientation of the route using map information if the position of the train is known more accurately.

Furthermore, asset monitoring can also take place on the basis of the inventive method. This monitoring can take place by way of RCS filtering (RCS=Radio Cross Section) when radar signals are used for the orientation measurement. In RCS filtering a selection is made using a determined RCS value on the basis of the received signal energy of individual targets or clusters or grouped targets.

For example, the density and/or moisture and/or health of the vegetation surrounding a rail region can be monitored with RCS filtering, or the condition of infrastructure, such as overhead line masts, for example, which comprises organic material, can be monitored. Organic material changes its reflective properties depending, for example, on moisture. The amount of material in the space or the density has an effect on the reflected signal energy. In general, objects in the environment of the rail vehicle and the condition thereof, provided it is correlated with the signal energy of the signals reflected by them, may thus be monitored.

The captured sensor data can also be combined to be able to determine the position and orientation of the rail vehicle or the position of objects in the environment of the rail vehicle more accurately. For example, certain sensors are particularly suitable for certain weather conditions. This sensor data can possibly be weighted in accordance with the current weather conditions in such a way that an adjusted measuring result is achieved.

The invention will be explained once again in more detail below on the basis of exemplary embodiments with reference to the accompanying figures. In the drawings:

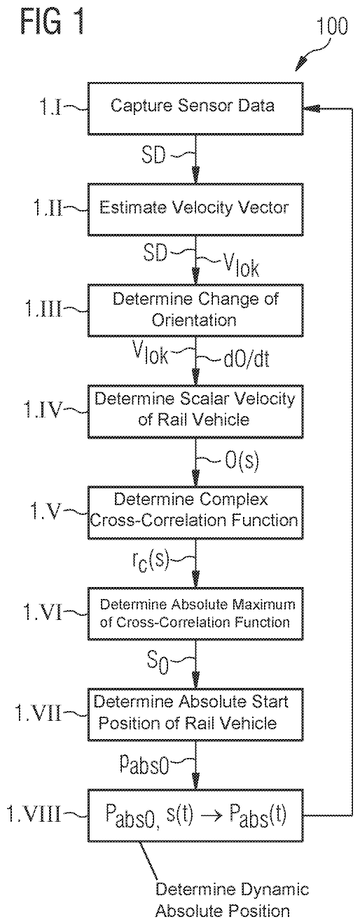

FIG. 1 shows a flowchart, which illustrates a method for orientation-based localization of a rail vehicle according to one exemplary embodiment of the invention,

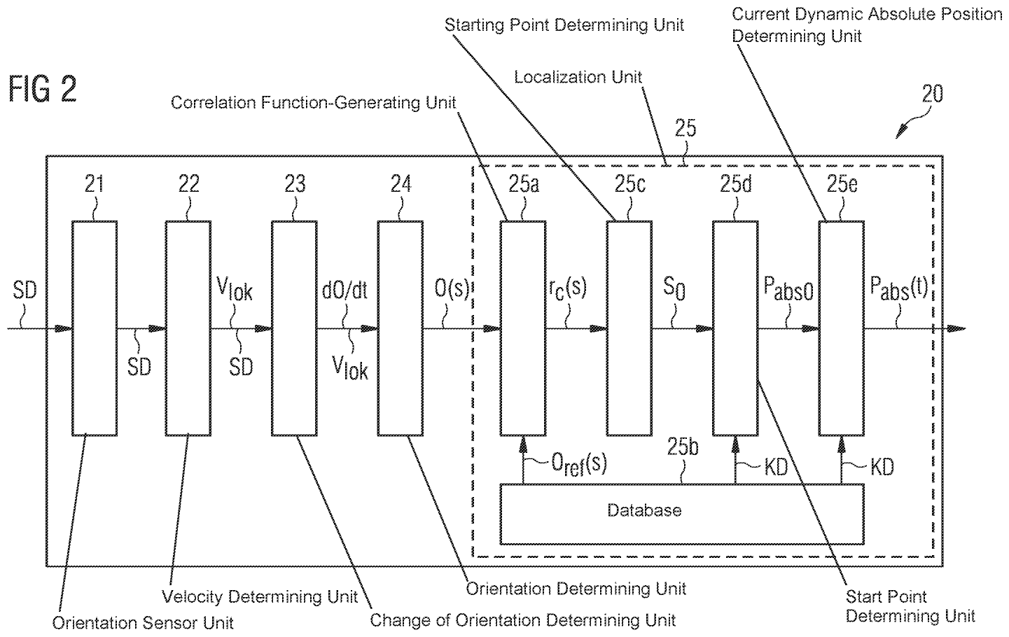

FIG. 2 shows a schematic representation of a localization facility according to one exemplary embodiment of the invention,

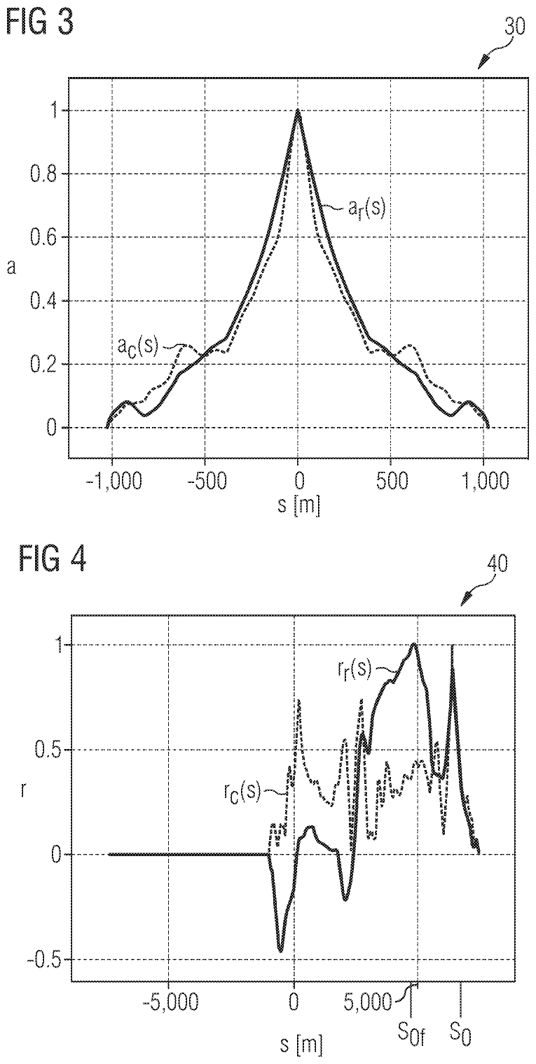

FIG. 3 shows a graph, which illustrates a real-valued and a complex-valued autocorrelation function between a measured orientation of a rail vehicle and reference data,

FIG. 4 shows a graph, which illustrates maxima of a real-valued and a complex-valued autocorrelation function between a measured orientation of a rail vehicle and reference data,

FIG. 5 shows a graph, which illustrates a displacement between an orientation curve determined by way of real-valued correlation and an orientation curve determined by way of complex-valued correlation,

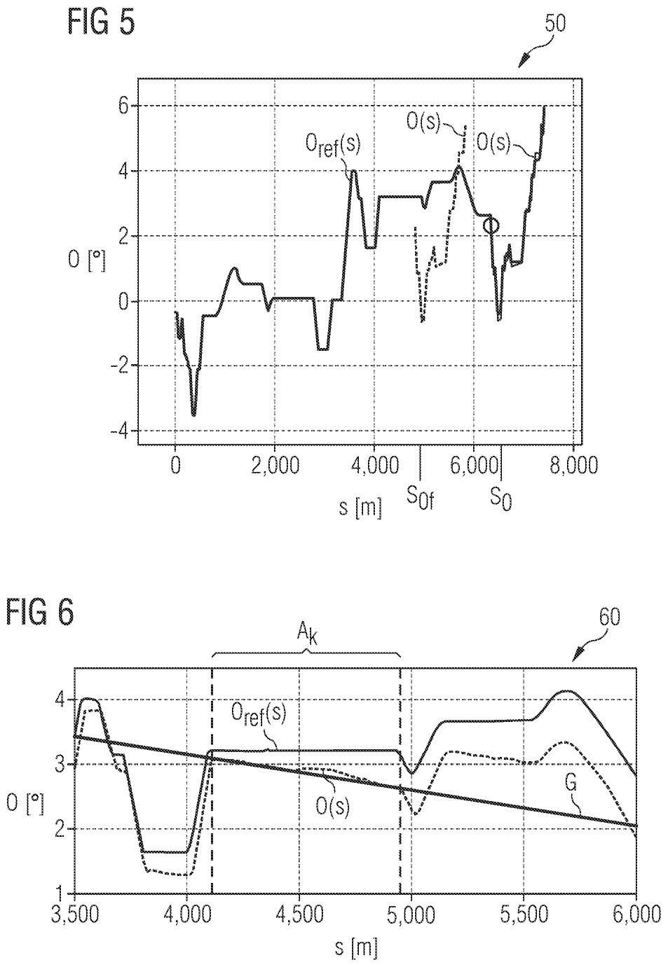

FIG. 6 shows a graph, which illustrates a calibration of an orientation sensor by comparing measured orientation data with reference data,

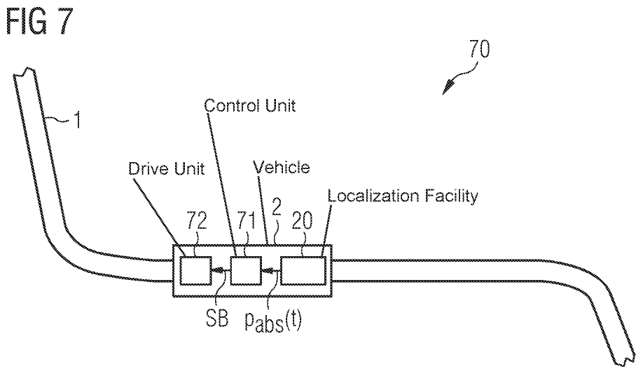

FIG. 7 shows a schematic representation of a rail vehicle according to one exemplary embodiment of the invention.

FIG. 1 shows a flowchart 100, which illustrates a method for orientation-based localization of a rail vehicle according to one exemplary embodiment of the invention.

In step 1.I, sensor data SD from the environment of a rail vehicle 2 is captured with the aid of a radar sensor.

A velocity vector V_{loc} relative to the environment is estimated in step 1.II on the basis of the radar sensor data SD. Since there is little traffic in the environment of a rail vehicle 2, at least outside of dense settlement, the environment behaves substantially statically compared to the traveling rail vehicle 2. Using the knowledge of changes in spacing of the rail vehicle 2 in relation to the environment and/or Doppler measurements it is therefore possible to determine or estimate a local velocity vector V_{loc}. A global velocity vector V or a global orientation O may not be determined directly using the local velocity vector V_{loc}, but an estimated scalar velocity v(t)=ds/dt of the rail vehicle 2 and a change of orientation dO/dt may be determined. It should be mentioned once again at this point that the change of orientation dO/dt can also be determined by way of other sensor measuring methods, such as acceleration sensor measurements or inertial sensor-measurements. Instead of by way of a measurement of sensor data from the environment of the rail vehicle 2, the estimated scalar velocity v(t) can also be determined by other measuring methods, such as odometry or satellite navigation.

23 In step 1.III, a change of orientation dO/dt is determined as a function of the time t using the determined local velocity vector V_{loc}.

26 In step 1.IV, a scalar velocity v(t) of the rail vehicle 2 27 is determined on the basis of the local velocity vector V_{loc}. The value of the scalar velocity v(t) corresponds to the amount of the local velocity vector V_{loc}. Furthermore, a distance-dependent orientation O(s) is estimated (see also equation (3)) by dividing the time-dependent change of orientation dO/dt by the scalar velocity v(t) of the rail vehicle 2 and integration according to the distance.

In step 1.V, what is known as a complex cross-correlation function r_{c}(s) is determined between the estimated distance-dependent orientation O(s) of the rail vehicle and reference data O_{ref}(s) of a distance-dependent orientation.

7 In step 1.VI, an absolute maximum of the cross-correlation function r_{c}(s) is determined. At the distance position so allocated to the maximum the starting point for the estimated orientation data O(s) lies in the reference data O_{ref}(s). The starting point s₀ of a traveled route is therefore exactly determined in the reference data O_{ref}(s) in step 1.VI.

In step 1.VII, an absolute start position of the rail vehicle is determined in a map by way of an absolute position p_{abs0} allocated to the starting point s₀ in the reference data O_{ref}(s).

Furthermore, in step 1.VIII, a dynamic absolute position p_{abs}(t) is determined by determining a covered path s(t) since the allocated absolute position Pabs0 and on the basis of a projection of the length of the covered path s(t) on a course of the route indicated in the map of the reference data.

Steps 1.I to 1.VIII are repeated as often as desired during the journey of the rail vehicle 2, so a precise and constantly updated position p_{abs}(t) of the rail vehicle 2 is always available.

FIG. 2 schematically represents a localization facility 20 according to one exemplary embodiment of the invention. The localization facility 20 is part of a control system of a rail vehicle 2 (see FIG. 7). The localization facility 20 comprises an orientation sensor unit 21, which is configured to capture radar sensor data SD, which is correlated with a change of orientation of a rail vehicle 2, from the environment of the rail vehicle 2.

The localization facility 20 also includes a velocity determining unit 22 and this is configured to determine a local velocity vector V_{loc} of the rail vehicle 2 on the basis of the determined radar sensor data SD. A kind of local map may be generated using the radar sensor data SD, with a movement V_{loc} of the rail vehicle 2 relative to the static structures of this local map likewise being determined by the radar sensor data SD.

The localization facility 20 also comprises a change of orientation determining unit 23 for determining a time-dependent change of orientation dO/dt of the rail vehicle 2 on the basis of the radar sensor data SD or the relative movement V_{loc} of the rail vehicle 2. A local orientation relative to a local map results using the direction of movement of the relative movement V_{loc} of the rail vehicle 2. A change dO/dt of the orientation can accordingly be calculated using this local orientation.

The localization facility 20 also comprises an orientation determining unit 24 for determining a distance-dependent orientation O(s) of the rail vehicle 2 on the basis of the change dO/dt of the orientation O(s) and of the scalar local velocity v(t).

On the basis of the scalar local velocity v(t)=ds/dt and the change dO/dt of the orientation O(s) of the rail vehicle 2, the orientation results according to

$$O ( s ) = \int \frac{d O}{dt} \cdot \frac{dt}{ds} ds . \qquad ( 3 )$$

The orientation O(s) may be calculated on the basis of the scalar local velocity v(t)=ds/dt and the change dO/dt of the orientation of the rail vehicle 2 therefore.

The localization facility 20 also has a localization unit 25 for determining an absolute position p_{abs}(t) of the rail vehicle 2.

Part of the localization unit 25 is a correlation function-generating unit 25a, which is configured to generate a complex cross-correlation function r_{c}(s) on the basis of the determined distance-dependent orientation O(s) of the rail vehicle 2 and on the basis of reference data O_{ref}(s) of a distance-dependent orientation. The correlation function-generating unit 25a receives the reference data O_{ref}(s) from a database 25b. The determined complex cross-correlation function r_{c}(s) is transmitted to a starting point determining unit 25c, which determines a starting point so in the reference data O_{ref}(s) at the location at which the maximum of the complex cross-correlation function r_{c}(s) is situated.

An absolute start position P_{abs0} of the rail vehicle 2 is determined by a start point determining unit 25d using the starting point s₀. The start point determining unit 25d determines an absolute start position Pabs0 r allocated to the starting point s₀ in the reference data O_{ref}(s), in a map KD, which it receives transmitted from the database 25b already mentioned.

Finally, a path s(t) is determined on the basis of the correlated reference data O_{ref}(s), which path the rail vehicle 2 has covered since passing the absolute position P_{abs0}. Subsequently, a current, dynamic absolute position p_{abs}(t) of the rail vehicle 2 is determined on the map KD using the determined path s(t) and a projection of this path s(t) onto the railroad on the map KD.

FIG. 3 represents a graph 30, which represents an auto-correlation a of an orientation of a rail vehicle 2 as a function of the covered distance s of the rail vehicle 2. In particular, a real-valued autocorrelation function aᵣ(s) (with solid lines) and a complex-valued autocorrelation function a_{c}(s) (with broken lines) of an orientation as a function of the distance s are shown.

The main lobe of the complex autocorrelation function a_{c}(s) at s=0 is narrower than the main lobe of the real autocorrelation function aᵣ(s). The complex autocorrelation function a_{c}(s) does have small sidelobes, however, which have a spacing of 600 m from the main lobe and have less than 30% of the correlation value of the main lobe. It does not have any high secondary maxima therefore, and promises a stable, distinct localization in the case of a cross-correlation with a reference signal.

FIG. 4 shows a graph 40, which illustrates a real-valued cross-correlation function rᵣ(s) (with solid lines) and a complex-valued cross-correlation function r_{c}(s) (with broken lines). The cross-correlation functions rᵣ(s), r_{c}(s) indicate a correlation value between an orientation O(s) of a rail vehicle 2 determined on the basis of sensor measurement data SD and a reference orientation O_{ref}(s) of a rail vehicle 2 determined on the basis of map data KD. In the case represented in FIG. 4, the actual starting point so lies at approximately 6,000 m and is illustrated by the absolute maximum of the complex-valued cross-correlation function r_{c}(s). By contrast, the absolute maximum of the real-valued cross-correlation function rᵣ(s) lies at approximately 4,900 m and therewith at the wrong location sof. When evaluating the real-valued cross-correlation function rᵣ(s), instead the secondary maximum at approximately 6,000 m has to be determined as a starting point so although this secondary maximum with a correlation of approximately 0.85 is lower than the main maximum with a correlation of 1. The complex-valued cross-correlation function r_{c}(s) at approximately 200 m and 3,000 m has secondary maxima with values of approximately 0.7. With 70% of the value of the main maximum, which has a value of 1, however, these are clearly attenuated so a distinct localization is possible.

FIG. 5 represents a graph 50, which illustrates a comparison of an orientation O(s) determined by measurement with a reference orientation O_{ref}(s). The orientation O(s), whose starting point s₀ was determined by way of the complex cross-correlation function r_{c}(s), obviously matches the reference orientation O_{ref}(s) very accurately. By contrast, an incorrect starting point s_{0f} would be found by way of the real-valued cross-correlation function rᵣ(s), so the two orientation functions O(s), Oref(s) would not match well either, and instead would be displaced relative to each other by the value s₀-s_{of}. Starting from the correct starting point s₀ it will be possible to determine the current route point via the projection of the covered distance onto the mapped route. An absolute position of the rail vehicle can also be determined from this since an absolute position in the map, and therewith also globally, is to be allocated to each point of the route.

FIG. 6 represents a graph 60, which illustrates a calibration of an orientation sensor by comparing measured orientation data O(s) with reference orientation data O_{ref}(s). The graph 60 shows orientation value in the angle unit.

As a rule, a sensor may not be exactly fitted in a rail vehicle 2 at the specified angle since increased accuracy is connected with disproportionate installation effort. A sensor installed in or on a rail vehicle 2 therefore has a deviation, in particular in its orientation, in respect of a predetermined measuring plane. As a result, determination of the change of orientation on the basis of the sensor measurement data SD, which is ascertained, for example, by the REMER method (REMER=Robust Ego Motion Estimation with Radar) already mentioned, supplies a constant rotation rate deviating from the value 0 in the case of travel in a straight line. Such a deviation is disadvantageous for forming a cross-correlation function r(k) as well as for other evaluation processes of the sensor data SD, such as object detection, for example. For this reason, it is expedient to determine the deviation angle β of a sensor and perform a calibration to be able to carry out more exact localization.

During calibration, firstly a long straight track section Ak is identified in the reference data O_{ref}(s) (drawn with solid lines), on which section the rail vehicle 2 has already traveled and orientation data O(s) (drawn in broken lines) has been recorded. A linear trend or a straight line G is subsequently determined in the corresponding measurement data section Aₖ at the measured orientation O(s) by way of a fitting process. The gradient m=Δφ/Δs of the straight lines G is subsequently used to determine the deviation β of the orientation of the radar sensor. For a straight-line course of the route with an angle in relation to a predetermined reference orientation of α=0, the following results, as already mentioned, in accordance with equation (2) for the deviation

$$β = arc sin ( l \frac{Δ ϕ}{Δ s} ) ,$$

where 1 describes the spacing of the sensor from the turning point of the rail vehicle. The rotation or deviation β can also be determined by way of regular checking.

FIG. 7 shows a schematic representation 70 of a track section or rail region 1 on which a rail vehicle 2 is underway in the direction of the arrow. The rail vehicle 2 has a localization facility 20 with which an absolute position p_{abs}(t) of the rail vehicle 2 is determined in the manner shown in conjunction with FIG. 1 to FIG. 6. The absolute position p_{abs}(t) is transmitted to a control unit 71, which transmits control commands SB to a drive unit 72.

To conclude, reference is made once again to the fact that the previously described methods and apparatuses are merely preferred exemplary embodiments of the invention, and that the invention can be varied by a person skilled in the art without departing from the scope of the invention insofar as it is specified by the claims. For the sake of completeness, reference is also made to the fact that use of the indefinite article “a” or “an” does not preclude the relevant features from also being present multiple times. Similarly, the term “unit” does not preclude this from comprising a plurality of components, which can possibly also be spatially distributed.

1-15. (canceled).

16. A method for orientation-based localization of a rail vehicle, the method comprising the following steps:
capturing sensor data correlated with a change of orientation (dO/dt) of the rail vehicle;
determining a time-dependent change of orientation (dO/dt) of the rail vehicle based on the sensor data;
determining an estimated velocity (Vloc) of the rail vehicle at least one of based on the captured sensor data or based on additionally captured sensor data;
determining a distance-dependent orientation (O(s)) of the rail vehicle based on the estimated velocity (Vloc) and the time-dependent change of orientation (dO/dt) of the rail vehicle; and
determining an absolute position (pabs(t)) of the rail vehicle by comparing the determined distance-dependent orientation (O(s)) of the rail vehicle with reference data (Oref(s)) of a distance-dependent orientation.

17. The method according to claim 16, which further comprises carrying out the comparison by determining a cross-correlation function (r(k)) between the determined distance-dependent orientation (O(s)) and the reference data (Oref(s)) of the distance-dependent orientation.

18. The method according to claim 17, which further comprises providing the cross-correlation function (r(k)) with a complex cross-correlation function (rc(s)).

19. The method according to claim 17, which further comprises providing the cross-correlation function (r(k)) with a real cross-correlation function (rr(s)).

20. The method according to claim 16, which further comprises capturing the sensor data correlated with the change of orientation (dO/dt) of the rail vehicle by using one of a plurality of sensor systems as follows:
a radar system, or
an inertial measuring unit, or
a satellite navigation system, or
an acceleration sensor system, or
a magnetic field sensor system, or
an ultrasound sensor system, or
a laser-based measuring system, or
a measuring system based on the modulation of radioactive radiation, or
a camera-based measuring system.

21. The method according to claim 16, which further comprises:
determining a scalar velocity (v(t)) of the rail vehicle based on the estimated velocity (Vloc);
determining a covered distance of the rail vehicle based on the scalar velocity (v(t)) of the rail vehicle; and
carrying out a calibration between the determined distance-dependent orientation (O(s)) and the reference data (Oref(s)) of the distance-dependent orientation based on the covered distance.

22. The method according to claim 16, which further comprises:
initially determining a starting point for the captured orientation data (O(s)) in the reference data (Oref(s)) corresponding to a starting point of a route traveled in the reference data (Oref(s)), by comparing the determined distance-dependent orientation (0(s)) of the rail vehicle with reference data (Oref(s)); and
determining an absolute start position (pabs0) of the rail vehicle by an absolute position in a map allocated to the starting point in the reference data (Oref(s)); and
determining a dynamic absolute position (pabs(t)) of the rail vehicle (2) by determining a covered path (s(t)) based on the correlated reference data (Oref(s)) and a projection of a length of the covered path (s(t)) on a course of a route indicated in the map.

23. The method according to claim 16, which further comprises checking a reliability of the determined absolute position (pabs(t)) of the rail vehicle by:
determining confidence values based on the determination of the orientation values (O(s), Oref(s)), or
determining, based on a curve shape of the cross-correlation function (r(k)), whether a distinct comparison is possible between the determined distance-dependent orientation (O(s)) of the rail vehicle and the reference data (Oref(s)).

24. The method according to claim 16, which further comprises carrying out a calibration of a sensor orientation of sensors of the rail vehicle by correlation of uncalibrated measurement data (O(s)) with reference data (Oref(s)).

25. The method according to claim 24, which further comprises based on at least one of the localization or the calibration, carrying out at least one of:
status monitoring or
asset monitoring.

26. The method according to claim 25, which further comprises at least one of:
carrying out status monitoring by performing one method step as follows:
creating a map by way of a specified trajectory, or
determining at least one of defects or errors in an existing map based on the specified trajectory, or
determining defects in a rail of a track system, or identifying at least one of a yawing or a side motion of the rail vehicle;
or
carrying out asset monitoring by performing one method step as follows:
determining at least one of density or moisture or health of vegetation surrounding a rail region, or
determining a condition of infrastructure including organic material.

27. A localization facility, comprising:
an orientation sensor unit for capturing sensor data correlated with a change of orientation (dO/dt) of a rail vehicle;
a change of orientation determining unit for determining a time-dependent change of orientation (dO/dt) of the rail vehicle based on the sensor data;
a velocity determining unit for determining an estimated velocity (Vloc) of the rail vehicle based on at least one of the captured sensor data or additionally captured sensor data;
an orientation determining unit for determining a distance-dependent orientation (O(s)) of the rail vehicle based on the estimated velocity (Vloc) and the determined time-dependent change of orientation (dO/dt) of the rail vehicle; and
a localization unit for determining an absolute position (pabs(t) of the rail vehicle by comparing the determined distance-dependent orientation (O(s)) of the rail vehicle with reference data (Oref(s)) of the distance-dependent orientation.

28. . A rail vehicle, comprising:
the localization facility according to claim 27;
a control unit for controlling a journey of the rail vehicle based on a position of the rail vehicle determined by the localization facility; and
a drive unit for driving the rail vehicle based on control commands of the control unit.

29. A non-transitory computer program product having a computer program which can be loaded directly into a memory unit of a control facility of a rail vehicle, having segments for carrying out all steps of the method according to claim 16 when the computer program is executed in the control facility.

30. A non-transitory computer-readable medium on which program segments which can be executed by a computer unit are stored in order to carry out all steps of the method according to claim 16 when the program segments are executed by the computer unit.
